(19) United States
(12) Patent Application Publication
(10) Pub. No.: US 2021/0056657 A1
(43) Pub. Date: Feb. 25, 2021

(54) DYNAMIC PLATFORM FOR MOBILITY ON DEMAND SERVICES

(71) Applicants: Ford Motor Company, Dearborn, MI (US); Massachusetts Institute Of Technology, Cambridge, MA (US)

(72) Inventors: Eric H. Tseng, Canton, MI (US); Yue Guan, Cambridge, MA (US); Anuradha Annaswamy, West Newton, MA (US)

(73) Assignees: Ford Motor Company, Dearborn, MI (US); Massachusetts Institute Of Technology, Cambridge, MA (US)

(21) Appl. No.: 16/550,037

(22) Filed: Aug. 23, 2019

(51) Int. Cl. G06Q 50/30; H04W 12/06; G06Q 30/02

(52) U.S. Cl. CPC G06Q 50/30; G06Q 30/0283; H04W 12/06

(57) ABSTRACT

A computer-implemented method includes receiving, from a passenger mobile device, a request message indicative of a passenger request for transportation services, determining, based on the request message, an updated estimated wait time (EWT) to accommodate the passenger, determining, based on the first EWT, a probability value indicative of whether the passenger mobile device will send an acceptance of a ride offer for passenger transport, generating, based on the probability value and a reference transportation mode, a price for the ride offer, and sending a proposal message to the passenger mobile device, the proposal message comprising the ride offer, the price for the ride offer, and an itinerary comprising pickup information, and distance information.

### TECHNICAL FIELD

The present disclosure relates to dynamic platforms for mobility on demand.

### BACKGROUND

Mobility on Demand (MoD) platforms match providers of on-demand transportation services to passengers through cloud-based computing platforms. Mobile devices and other computers may be used to match drivers (the service providers) with customers seeking on-demand transportation. The MoD system may be balanced when ridership is high, wait times for passengers seeking transportation and the drivers seeking available paying passengers are minimized, and overall revenues are high. High ridership may result when passengers have a relatively high level of certainty that their wait times for transportation will be short, and that they will receive good value for their transportation money spent. Passenger wait times are often lowest when the service providers have a relatively high level of certainty that there will be plentiful available passengers willing to pay attractive rates, which may encourage a high level of service partner participation.

Conventional systems for balancing these competing interests have used dynamic pricing strategies that adjust transportation fees based on instantaneous demand fulfillment. However, conventional MoD pricing strategies do not address the problem of balancing and maximizing all competing interests in a MoD system when one or more of these elements face uncertainty.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2A is a flow diagram illustrating one embodiment of the present disclosure.

FIG. 2B is a table for determining a probability that an offer for rideshare services will be accepted according to an embodiment of the disclosure.

FIG. 3 is a functional schematic of a computing architecture for use in embodiments of the present disclosure.

FIG. 4 depicts a functional block diagram of a cloud computing infrastructure for use in embodiments of the present disclosure.

FIG. 5 is an example flow diagram of a method for practicing an embodiment in accordance with the present disclosure.

FIG. 6 depicts an example graph depicting estimated wait time (EWT) with respect to time to embodiments of the present disclosure.

FIG. 7 depicts a chart for comparison of actual wait time (AWT) for all passengers and the actual AWT with and without the dynamic pricing strategy, respectively.

FIG. 8 and FIG. 9 illustrate the prices of the rideshare service compared with those of a reference mode of transportation, respectively.

### DETAILED DESCRIPTION

### Overview

The systems and methods disclosed herein are configured for a system to receive a request from a prospective passenger mobile device for on-demand rideshare service, and in response provide an offer to the requesting mobile device that is priced to minimize wait time and maximize a probability of acceptance by the requesting prospective passenger. Disclosed methods may use an analytical model that incorporates a Markov Decision Process with alternative minimization algorithms that account for socioeconomic variables of the passengers making the request(s), and accounts for uncertainties such as unknown wait times for a ride.

The prospective passenger messages requesting rideshare services may include date, time, location, identity, destination address, and/or other information with which a rideshare driver may be enabled by the system to propose a rideshare price and pickup time. Some aspects of the present disclosure may determine the possible updated estimated wait time (EWT) if the passenger would be accommodated. The system or another computing resource may make the EWT determination based, at least in part, on the passenger's request message. The system may determine a probability value of whether the passenger (using their mobile device) will accept the proposed rideshare offer. The system may generate a price for the ride offer based on the probability value and the EWT, and send the proposal to the passenger mobile device. The proposal message may include the ride offer, the price for the ride offer, and an itinerary specifying pickup information, and other information such as, for example, distances and navigational information for the passenger.

Embodiments may enhance the economic efficiency of the shared mobility on demand (MoD) system using prospect theory to capture passenger behavior under various uncertainty scenarios inherent with mobility on demand services. The proposed dynamic pricing strategy incorporates an Alternative Minimization (AltMin) algorithm developed for dynamic routing that may incentivize passengers to accept an offer for rideshare services while balancing demand and supply for those on-demand services.

These and other advantages of the present disclosure are provided in greater detail herein.

### Illustrative Embodiments

The disclosure will be described more fully hereinafter with reference to the accompanying drawings, in which exemplary embodiments of the disclosure are shown, and which are not intended to be limiting.

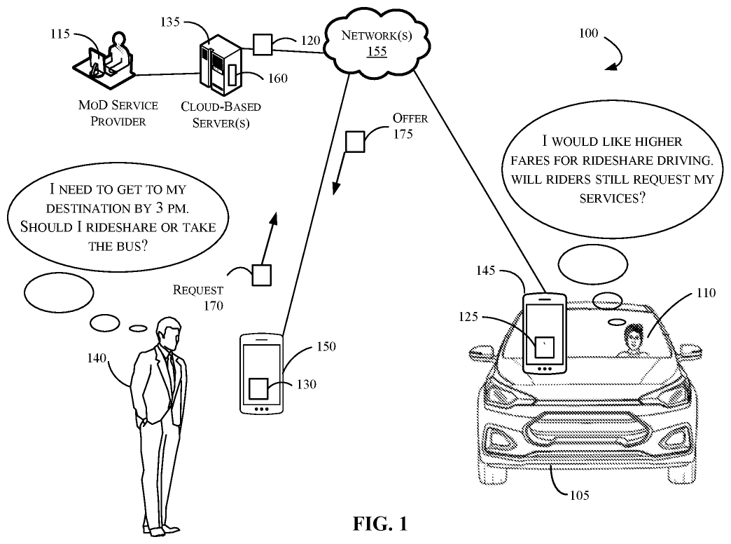

FIG. 1 depicts an example computing environment 100 in which a vehicle 105 is driven by rideshare driver 110. In the present example, the rideshare driver 110 may be a service partner working with a mobility on demand (MoD) platform provider 115. The MoD platform provider 115 may provide a cloud-based computing platform that utilizes a rideshare application 120 to coordinate a rideshare marketplace via one or more cloud-based server(s) 135. The rideshare application 120 may be configured to operate on mobile devices, computers, handheld devices, etc., to match rideshare driver(s) (e.g., the rideshare driver 110) with rideshare passenger(s), e.g., a rideshare passenger 140, looking for on-demand transportation.

The rideshare application 120 may run on respective mobile devices used by both drivers (also referred to as rideshare application 125) and passengers (also referred to as rideshare application 130), and may be delivered as stand-alone applications, or as shown in FIG. 1, as a software service delivered via the cloud-based server(s) 135. For example, the mobile device 145 (operated by the rideshare driver 110) may run an instantiation of the rideshare application 120, depicted in FIG. 1 as the rideshare application 125. The rideshare application 120 may also be run as an instantiation 130 on a mobile device 150, depicted in FIG. 1 as the rideshare application 130, wherein the mobile device 150 is operated by the rideshare passenger 140. The cloud-based server(s) 135 may deliver the rideshare applications 125 and 130 (also collectively referred to as the rideshare application 120) to devices, such as mobile devices 145 and 150, via one or more network(s) 155. In another aspect, the rideshare applications 125 and 130 shown in FIG. 1 may operate locally on each respective device as an installed application 120.

The rideshare driver 110 is depicted in FIG. 1 driving the vehicle 105 and using the rideshare application 125 to identify potential rideshare passengers. Also depicted is a rideshare passenger 140, using the rideshare application 130 to determine whether he would like to use a rideshare service to travel to his destination, or use other available options. The rideshare passenger 140 may face uncertainty as to the best value as he considers other available options outside of the MoD service. For example, the rideshare passenger 140 may also consider walking or taking a personal mobility device (e.g., an electric scooter, bike, or other such apparatus). The rideshare passenger 140 has the logical objective to balance the personal convenience of a brief wait for a rideshare service that will most quickly deliver him/her to a destination, with value received for dollars spent.

In the present example shown in FIG. 1, the MoD platform provider 115 may have two logical objectives: one objective is to maximize revenue of the MoD service per transaction, which may also keep the supply of available service partners (the rideshare drivers) strong. Another logical objective may be maximization of overall use of the MoD platform (and thus, maximize the revenue generated by paying customers). These objectives may be best accomplished when supply and demand are balanced and optimized.

The balance of supply and demand for MoD services can be characterized using various Key Performance Indicators (KPIs) that can include, for example, an average estimated waiting time (EWT) of passengers who are currently in a pickup queue, an idle rate that indicates a percentage of driver time spent driving paying passengers with respect to the overall period of free time available to drive the driver's vehicle, and a completion rate indicative of a percentage of transportation requests that mature into transactions.

Of these three example KPIs, embodiments of the present disclosure may focus on a dynamic pricing strategy that maximizes ridership and revenues using the EWT indicator. As used herein, EWT refers to the average estimated waiting time of the passengers who are currently in a pickup queue, i.e., that have accepted the ride offers but have not yet been picked up.

EWT is a panel parameter that varies with time. Accordingly, EWT may be denoted as EWT(t). In one aspect, a MoD ecosystem can be characterized in terms of market health by evaluating how the EWT varies with respect to time (EWT(t)). A sharp increase in EWT(t) may imply that demand exceeds supply for a span of time, and thus, the prices during this time should be increased. The inverse relationship and response may also hold true.

According to one or more embodiments of the present disclosure, one processor-implemented method may balance the competing interests discussed above by regulating the EWT(t) to be within a predetermined threshold of values associated with a target value. One tool for performing this analysis and response can include a transactive controller 160 (which may be part of or accessible by the rideshare application 120). The transactive controller 160 may be configured and/or programmed with an analytical model that uses, among other analytical tools, a Markov Decision Process (MDP), and an algorithm based, at least in part, on the concept of Alternate Minimization. In some aspects, the transactive controller 160 may improve dynamic routing algorithms.

In one example, the prospective rideshare passenger 140 may generate a request 170 for a rideshare using the rideshare application 130 on the passenger mobile device 150. The rideshare request 170 can indicate an interest by the rideshare passenger 140 to possibly engage the services of a rideshare driver (e.g., the rideshare driver 110). The rideshare request may trigger the rideshare platform to return an offer for transportation 175, which the rideshare passenger 140 may evaluate to determine whether it is the most desirable option for transport.

When a new request for a rideshare is received by the cloud-based server(s) 135, the transactive controller 160 may compute a driver itinerary to accommodate the new passenger 140 subject to an objective function, and one or more system-defined constraints. The itinerary can include the pickup/drop-off locations associated with the rideshare, the expected pickup/drop-off times for the prospective passenger 140, walking distances to and from the pickup/drop-off locations, and information indicative of known other passengers with whom the requesting passenger 140 may share the ride. The cloud-based server(s) 135 may send the rideshare offer 175 to the rideshare passenger 140, and the passenger 140 may be provided options within the rideshare application 130 to accept the offer and engage the services of the rideshare driver 110.

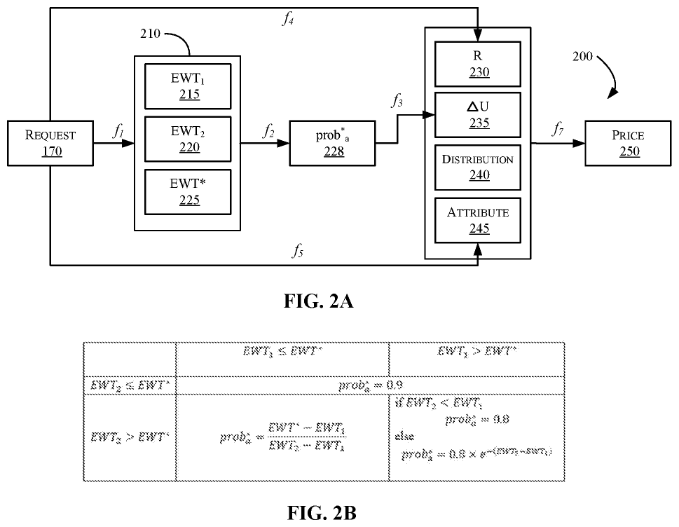

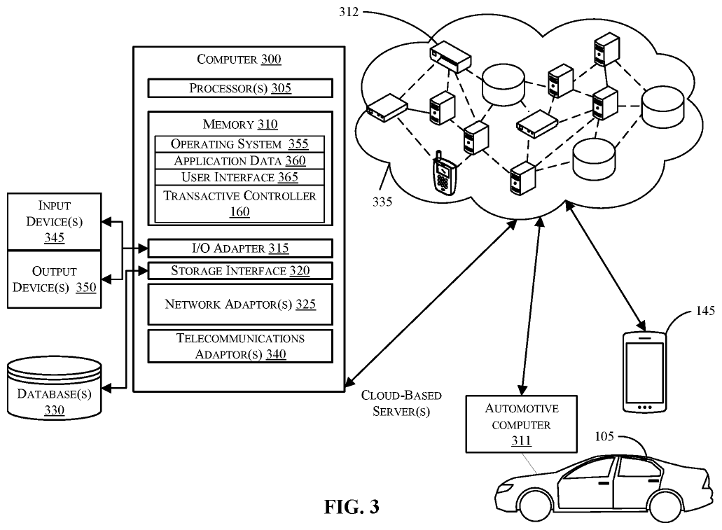

FIGS. 2A and B are flow diagrams illustrating one embodiment of the present disclosure. FIG. 1 is considered with reference to FIGS. 2A and 2B. With continued reference first to FIG. 1, the rideshare passenger 140, depicted as determining whether a rideshare or a bus may be the best transportation mode to reach a particular destination, may wish to review the costs and timelines associated with the specified various modes of travel to make a decision to select the mode that best meets the passenger's needs at that moment. As part of the determination, the prospective rideshare passenger 140 may generate the request 170 for a rideshare using the rideshare application 130, which may be installed and/or running on the passenger's mobile device 150. The rideshare application 130 may transmit the rideshare request 170 to one or more cloud-based server(s) 135 that may run the MoD platform described herein.

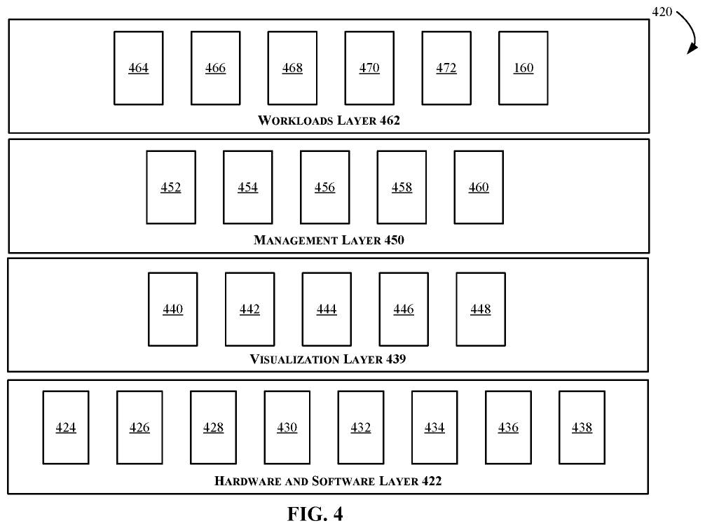

In some aspects, the cloud-based server(s) 135, described in greater detail with respect to FIG. 3, may include one or more processor(s) 305 that may be configured and or programmed to perform the analytical steps associated with embodiments of the present disclosure. Example analytical steps are described in greater detail with respect to FIG. 2A.

With reference now to FIG. 2A, a block diagram 200 depicts analytical steps for providing an optimized price 250, that may be included in the offer 175, after receiving the request 170. By way of an overview, the processor(s) 305 (shown in FIG. 3) may calculate the price 250 responsive to receiving the request 170 for the rideshare at a timestamp t. In one example, the request may be associated with one or more passenger demographics of the requester, and/or features associated with the ride request. For example, the expression,

request=(passenger, requirement) (1)

summarizes the request specifications and socio-demographics of the passenger that may impact an outcome as to whether the passenger selects the rideshare service or another mode of transportation. The socio-demographics of a potential passenger (e.g., the passenger 140) may be based, at least in part, on known associations with demographic choices and categories of rideshare customers.

For example, in equation (1) “passenger” denotes one or more quantified associations between geographic region, passenger income, time, date, and other information that may be known based on various studies, surveys, and data sources. The denotation passenger reflects associations that quantify known socio-demographic characteristics of rideshare customers with quantifiable values. For example, rideshare customers having an average income of x dollars monthly may have a likelihood of y to take a bus between the weekday hours of 6 am and 9 am. While an exhaustive list of known socio-demographic examples that may be correlated to a rideshare or other transportation choice may be outside of the scope of the present description, it is appreciated that such correlations are known in the art, observable, and may be quantified to provide analytical weights for observed socio-demographic characteristics of rideshare customers.

In equation (1) of FIG. 2A, “requirement” denotes the features regarding the specific ride request 170, such as, for example, a requested pickup location, a destination(s) associated with the potential rideshare, information indicative of walking distances, and other information.

The processor(s) 305 may determine estimated waiting time from three perspectives, which are collectively grouped in FIG. 2A and identified as estimated wait time (EWT) 210. The EWT 210 may include: an EWT₁215 before the request 170 is received; an EWT₂220, which describes the waiting time between when the request is received and when the ride offer 175 is sent to the mobile device 150 and accepted by the passenger 140; and finally, EWT*225, which represents a value associated with a desired (e.g., optimized) estimated waiting time that may provide the highest probability for a desired outcome of passenger acceptance of the offer. For example, after evaluation of wait times and outcomes, in one example embodiment, 8 minutes may be a desired waiting time to use as a benchmark value.

The processor(s) 305 may calculate the EWT₁ 215 from a current route that has been derived using an alternative minimization (AltMin) algorithm. The AltMin algorithm is a dynamic routing algorithm that dynamically optimizes routes, so that travel time and costs are minimized. In some aspects, the AltMin algorithm can accommodate real-time rideshare requests from passengers using online tools as described herein. Examples of alternative minimization algorithms are described in the publication titled, “A Dynamic Routing Framework With Space Windows For Shared Mobility Services,” by Y. Guan et al., (2017) ACM Transactions on Cyber-Physical Systems, Special Issue on Transportation Cyber-Physical Systems (which is incorporated herein by reference), and in the publication titled, “Transactive Control in Smart Cities,” by Annaswamy, A. M., et al. (2018), Proceedings of the IEEE, 106(4), 518-537 (which is also incorporated herein by reference),

The processor(s) 305 may next determine an estimated waiting time during when the request 170 is received by the cloud-based server(s) 135 and offer acceptance, and finally, the desired estimated waiting time EWT*225, which may include one or more predetermined value(s) for target waiting times. In this manner, EWT₂ may be expressed as a function f₁ of the request 170, which may describe the waiting time after the rideshare request 170 is accommodated and the rideshare passenger 140 accepts the ride rideshare offer 175. In mathematical notation, this may be denoted as EWT₂=f₁(request, ·) using the AltMin algorithm.

The processor(s) 305 may determine a probability that the passenger will accept the rideshare offer 175, depicted as prob*ₐ228. This probability is depicted in FIG. 2A as a function f₂ of the EWT 210. If described in mathematical notation, the probability of acceptance of the offer is described as

prob*ₐ=f₂(EWT₁, EWT₂, EWT*) (2)

where prob*ₐ is the probability (228) that the passenger sending the rideshare request 170 will accept the rideshare offer 175, and is a mathematical function f₂ of the EWT 210. FIG. 2B depicts a table of example probability estimations based on the EWT 210.

Once the processor(s) 305 determines the desired probability of acceptance prob*ₐ 230, in some embodiments the next step can include determining a desired difference between perceived utility for the services at issue, depicted in FIG. 2A as AU 235. More specifically, the relative utility that the rideshare passenger 140 perceives of the rideshare service offer with respect to the reference mode, is denoted as ΔU* in the mathematical representations described hereafter. Assuming that each potential passenger (e.g., the rideshare passenger 140) has a binary decision to make—to accept the rideshare offer 175 or take another mode of transportation (described as a reference transportation mode R) as an alternative; thus according to the discrete choice model, prob*ₐ 230 may result from ΔU* as represented by,

$$p r o {b}_{a}^{*} = \frac{1}{1 + {e}^{- Δ {U}^{*}}} . \qquad ( 3 )$$

Therefore, the relative utility of the rideshare service that the rideshare passenger 140 perceives with respect to the reference mode ΔU* can be calculated reversely via a discrete choice model through a mathematical representation of ΔU*=f₃(prob*ₐ), such that

$$Δ {U}^{*} = ln ( \frac{{prob}_{a}^{*}}{1 - {prob}_{a}^{*}} ) . \qquad ( 4 ) .$$

The function calculating price 250 to include in the rideshare offer 175 may further include defining an itinerary of the trip being requested, and including portions of the itinerary as one or more attributes. For example, in mathematical notation, one can define the itinerary of the trip having trip portions that include walking to the pick-up point WalkTₚ, waiting for the rideshare service WaitT, riding in the rideshare RideT, and walking from the drop-off point to the destination WalkT_{d}. These itinerary steps may be represented as,

attribute=[WalkTₚ,WaitT, Ride, WalkT_{d}]

where WalkTₚ,WaitT, RideT,WalkT_{d} are the trip steps in the itinerary. In some aspects, the processor(s) 305 may retrieve the itinerary of the reference mode from one or more publicly available sources including, for example, online global positioning system information, map APIs, public transportation, etc. The processor(s) 305 may denote the actual utility of the reference mode as R=f₄(request), which may be mathematically represented as,

R=a+bₚ·WalkTₚ+b_{w}·WaitT+bᵣ·RideT+b_{d}·WalkT_{d}+γ·ρ. (5)

The processor(s) 305 may derive the itinerary for the rideshare offer 175 via the AltMin dynamic routing algorithm, described mathematically as attribute=f₅(request).

According to one embodiment, the processor(s) 305 may determine the relative utility ΔU 235, describing a quantified perception of the utility of taking the rideshare service with respect to the reference mode of transportation R 230. Stated in another way, the relative utility ΔU 235 quantifies how valuable the rideshare passenger 140 may find the rideshare service offer given the other available information at the time of decision making. The relative utility ΔU 235 can be based on prospect theory, denoted as,

ΔU=f₆(R, attribute, distribution, price), (6)

where price (e.g., the price 250) is unknown, and the distribution is a quantified and/or estimated value representing the distribution of the uncertain utility that the rideshare passenger 140 will associate with the rideshare offer 175. The uncertain utility, based upon historical records, can derive from quantified values associated with uncertainty in waiting, riding and walking times to arrive at the destination from the starting point. For example, Let ΔU=ΔU*, and the actual probability of acceptance probₐ will equate to the desired probability of acceptance prob*ₐ.

The function f₆ may be a function that describes ΔU, a perceived relative utility of taking the rideshare service with respect to the reference transportation mode R 230. The reference transportation mode R may represent any known available mode of transportation used by the passenger 140, and/or by demographics like the passenger 140. For example, the rideshare passenger 140 may be inclined to take the bus as a preferred mode of transportation. Describing a prospect theory-based mathematical relationship between the perceived utility of the rideshare service ΔU, and the reference mode of transportation R,

$$\begin{matrix} Δ U = {\int }_{{u}_{1}}^{{u}_{2}} V ( u ) \frac{d}{du} ( π ( F ( u ) ) ) du & ( 7 ) \\ V ( u ) = \{ \begin{matrix}{( u - R )}^{{β}^{+}} , if u \geq R \\ - {λ ( R - u )}^{{β}^{-}} , if u < R\end{matrix} & ( 8 ) \\ π ( F ( u ) ) = exp ( - {( - ln F ( u ) )}^{α} ) , α < 1 & ( 9 ) \\ F ( u ) = {\int }_{- ∞}^{u} f ( τ ) dτ & ( 10 ) \\ u = a + {b}_{p} \cdot {WalkT}_{p} + {b}_{w} \cdot WaitT + {b}_{r} \cdot RideT + {b}_{d} \cdot {WalkT}_{d} + γ \cdot ρ , & ( 11 )\end{matrix}$$

where u is the actual utility of the passenger taking the rideshare service, which may be a weighted sum of various travel time cost terms. Stated another way, u may be considered a set of attributes that can describe time cost events associated with traveling such as, for example, waiting time, walking times, riding times, etc. In some aspects, u can be a random variable distributed in a closed interval [u₁, u₂]. The functions f (u) and F(u) are corresponding Probability Density Function (PDF) and Cumulative Distribution Function (CDP), respectively. R is an actual utility of the reference transportation mode as an alternative if the passenger decides not to take the rideshare service, which may be a known value from a lookup table stored in the computer-readable memory described herein. V(·) may represent a calculation for the passenger's perception of the utility of taking the rideshare service relative to the reference transportation mode (a first irrationality, which may be characterized as loss aversion), and π(·) may determine an approximated value indicative of a passenger perception of those probabilities (i.e., the second irrationality, characterized as an overreaction to small probabilities and underreaction to large probabilities). Accordingly, in equations (8) and (9) the values α, β⁻, β⁺ and γ are parameters associated with prospect theory, which may be derived from surveys and other market-based data, and are well-understood in the art of prospect theory evaluations.

The function f₆ describes a determination of ΔU 235, which may describe a perceived relative utility of taking the rideshare service with respect to the reference transportation mode based upon prospect theory. The function f₆ may monotonically decrease with the price 250 and may be continuous. Therefore, the processor(s) 305 may calculate the price 250 reversely with the mathematical determination,

price=f₇(U*, R, attribute, distribution) , (12)

where f₇ is the inverse of f₆. Accordingly, an overall dynamic pricing algorithm may be mathematically summarized by the expression,

price=f₇(f₃(f₂(EWT₁, f₁(request), EWT*)),f₄(request), f₅(request), distribution) (13).

FIG. 3 depicts a functional schematic of a computing architecture 300, with which techniques and structures for providing the systems and methods disclosed herein may be implemented. The environment and system described herein can be implemented in hardware, software (e.g., firmware), or a combination thereof.

As shown in FIG. 3, a computer 300 may include the one or more processor(s) 305, a memory 310 communicatively coupled to the one or more processor(s) 305, and one or more input/output adapters 315 that can communicatively connect with external devices. The one or more cloud-based server(s) 135 may be substantially similar to, or identical to the computer 300. The computer 300 may operatively connect to and communicate information with one or more internal and/or external memory devices such as, for example, one or more databases via a storage interface 320. The computer 300 may include one or more network communications adapter(s) 325 enabled to communicatively connect the computer 300 with the one or more networks 335.

The one or more networks 335 may be substantially similar to or identical to the network(s) 155 depicted with respect to FIG. 1. In some example embodiments, the network 335 may be or include a telecommunications network infrastructure. In such embodiments, the computer 300 can further include one or more telecommunications adaptor(s) 340. The computer 300 may further include and/or connect with one or more input device(s) 345 and/or one or more output devices 350 through the I/O adapter(s) 315.

The one or more processor(s) 305 are collectively a hardware device for executing program instructions (aka software), stored in a computer-readable memory (e.g., the memory 310). The one or more processor(s) 305 can be a custom made or commercially-available processor, a central processing unit (CPU), a plurality of CPUs, an auxiliary processor among several other processors associated with the computer 300, a semiconductor based microprocessor (in the form of a microchip or chipset), or generally any device for executing instructions.

The one or more processor(s) 305 may be disposed in communication with one or more memory devices (e.g., the memory 310 and/or one or more external databases 330, etc.) via a storage interface 320. The storage interface 320 can also connect to one or more memory devices including, without limitation, one or more databases 330, and/or one or more other memory drives (not shown in FIG. 3) including, for example, a removable disc drive, a vehicle computing system memory, cloud storage, etc., employing connection protocols such as serial advanced technology attachment (SATA), integrated drive electronics (IDE), universal serial bus (USB), fiber channel, small computer systems interface (SCSI), etc.

The memory 310 can include any one or a combination of volatile memory elements (e.g., dynamic random access memory (DRAM), synchronous dynamic random access memory (SDRAM), etc.) and can include any one or more nonvolatile memory elements (e.g., erasable programmable read only memory (EPROM), flash memory, electronically erasable programmable read only memory (EEPROM), programmable read only memory (PROM), etc.

The instructions in the memory 310 can include one or more separate programs, each of which can include an ordered listing of computer-executable instructions for implementing logical functions. In the example of FIG. 3, the instructions in the memory 310 can include an operating system 355. The operating system 355 can control the execution of other computer programs such as, for example the transactive contro11er160, and provides scheduling, input-output control, file and data management, memory management, and communication control and related services.

The program instructions stored in the memory 310 can further include application data 360, and instructions for controlling and/or interacting with the computer through a user interface 365 such as, for example, the input device(s) 345.

The I/O adapter 315 can connect a plurality of input devices 345 to the computer 300. The input devices can include, for example, a keyboard, a mouse, a microphone, a sensor, etc. The output device 350 can include, for example, a display, a speaker, a touchscreen, etc.

The I/O adapter 315 can further include a display adapter coupled to one or more displays. The I/O adapter 315 can be configured to operatively connect one or more input/output (I/O) devices 350 to the computer 300. For example, the I/O adapter 315 can connect a keyboard and mouse, a touchscreen, a speaker, a haptic output device, or other output devices. The output devices 350 can include but are not limited to a printer, a scanner, and/or the like. Other output devices can also be included, although not shown. Finally, the I/O devices connectable to the I/O adapter 315 can further include devices that communicate both inputs and outputs, for instance but are not limited to, a network interface card (NIC) or modulator/demodulator (for accessing other files, devices, systems, or a network), a radio frequency (RF) or other transceiver, a telephonic interface, a bridge, a router, and the like.

According to some example embodiments, the computer 300 can include a telecommunications adapter 340. The telecommunications adapter 340 can include a global positioning system (GPS), cellular, mobile, and/or other communications protocols for wireless communication.

The network 335 may be the Internet, a private network, public network or other configuration that operates using any one or more known communication protocols such as, for example, transmission control protocol/Internet protocol (TCP/IP), Bluetooth®, Wi-Fi, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples, can be an IP-based network for communication between the computer 300 and any external device. The network(s) 335 may transmit and receive data between the computer 300 and devices and/or systems external to the computer 300. The network 335 can also be and/or include a packet-switched network such as a local area network, wide area network, metropolitan area network, the Internet, or other similar types of network environment.

The network 335 may include and/or be part of a cloud computing environment for delivery of one or more services, platforms, etc., described herein. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing, as used herein, is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least four service models, and at least four deployment models.

Characteristics of a cloud computing model may include on-demand self-service tools for users such as the rideshare driver 110 and the rideshare passenger 140 to utilize with a provided service. A cloud consumer can unilaterally provision computing capabilities, such as server time and network storage (which, in some embodiments, may include data associated with rideshare requests 170, rideshare offers 175, identity information associated with rideshare passengers 140, etc.), as needed automatically without requiring human interaction with the MoD platform provider 115.

Characteristics of a cloud computing model may further include broad network access. For example, capabilities are often available over a network (e.g., one or more network(s) 155 and/or 335, as depicted in FIGS. 1 and 3, respectively) and accessed through standard mechanisms that promote use by heterogeneous thin or thick client platforms (e.g., mobile phones, laptops, vehicle infotainment system(s), etc.).

Cloud computing platforms may also include and/or utilize resource pooling such that the MoD platform provider 115 may provide computing resources to the cloud-based server(s) 135 to serve multiple consumers using a multi-tenant model, with different physical and virtual resources dynamically assigned and reassigned according to demand. For example, the rideshare driver 110 may utilize the rideshare application 125 on the mobile device 145, and tens, hundreds, etc. of other rideshare drivers (not shown in FIGS. 1, 3) may also (simultaneously) use similar services that access the same resources on the cloud-based server(s) 135. There is a sense of location independence in the embodiments such that the passenger consumer may have no control over or knowledge of the exact location of the provided resources but can be able to specify location at a higher level of abstraction (e.g., country, state, or datacenter). 100611 Cloud computing platforms and infrastructure, such as the cloud-based server(s) 135, for example, may provide Software as a Service (SaaS). SaaS is understood as a capability provided to the consumer (e.g., the rideshare passenger 140 and/or the rideshare driver 110) to use the provider's application 120 running on a cloud infrastructure. The rideshare application 120 is accessible from various client devices (e.g., the mobile device 145 (as 125), the mobile device 150 (as 130), one or more automotive computing systems, etc.) through a thin client interface such as a web browser (e.g., web-based e-mail). The user does not manage or control the underlying cloud infrastructure including the network(s) 335, 155 or, servers, operating systems, storage, or even individual application capabilities, with the possible exception of limited user-specific application configuration settings.

The MoD platform provider 115 may also provide a Platform as a Service (PaaS), which can include a capability provided to the rideshare passenger 140 and/or the rideshare driver 110 to deploy, onto the cloud infrastructure, consumer-created or acquired applications that are created using programming languages and tools supported by the provider. The consumer does not manage or control the underlying cloud infrastructure including the network(s) 335, 155, operating system 355, or databases 330, but has control over the deployed rideshare applications 120, 125, and 130.

The network 335 depicts a cloud computing environment for use in practicing the teachings embodied herein. As shown in FIG. 3, the cloud computing environment may include one or more cloud computing nodes 312 with which local computing devices may be used by rideshare drivers 110, rideshare passengers 140, etc. Example devices may include, for example, the mobile device 145, an automotive computer 311, operational as part of the vehicle 105, etc. In some example embodiments, the cloud computing nodes 312 can communicate data with one another. They can be grouped physically or virtually in the one or more network(s) 335 and/or 155. The various types of groupings may provide an infrastructure, one or more platforms, and/or software as services that a cloud consumer such as the rideshare driver 110 and/or the rideshare passenger 140 may use independently without necessarily requiring software resources on the client side (e.g., on a local computing device such as the mobile devices 145, 150, the automotive computer 311, etc.). It is understood that the types of computing devices shown in FIGS. 1 and 3 are intended to be illustrative only and that the cloud computing nodes 312 and the cloud computing environment 335 can communicate with any type of computerized device over any type of network and/or network addressable connection (e.g., using a web browser).

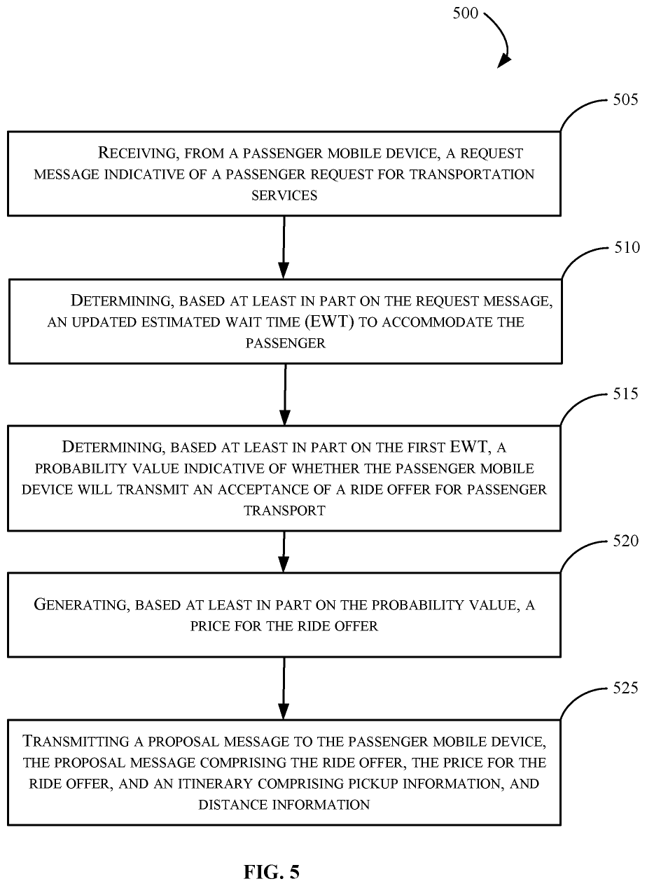

Referring now to FIG. 4, a set of functional abstraction layers 420 provided by the computing environment 100 and/or 300 is depicted, in accordance with an example embodiment. It should be appreciated that the components, layers, and functions of the abstraction layers 420 depicted are illustrative only, and embodiments of the invention are not limited thereto. As depicted, the following layers and corresponding functions are provided:

A hardware and software layer 422 can include hardware and software components. Examples of hardware components can include, for example, mainframes 424, one or more Reduced Instruction Set Computer (RISC) and/or architecture-based servers 426, one or more servers 428, one or more blade servers 430, one or more storage devices 432, and one or more network(s) and networking components 434. In some embodiments, the software components can also include network application server software 436 and/or database software 438. The cloud-based server(s) 335, 135 are an example of hardware and software layer 422 device(s).

A virtualization layer 439 can provide an abstraction layer from which the following examples of virtual entities can be provided: virtual servers 440, virtual storage 442, virtual networks 444 (which can include virtual private networks), virtual applications and operating systems 446, and virtual clients 448.

In one example, a management layer 450 can provide the functions described below. A resource provisioning module 452 can provide dynamic procurement of computing resources and other resources that can be utilized to perform tasks within the computing architecture (depicted generally in FIG. 3). A metering and pricing resource 454 that can provide cost tracking for one or more resources utilized within the cloud computing environment, and also provide for billing and invoicing for consumption of these resources. In one example, the metering and pricing resources can include the dynamic pricing structures described with respect to FIGS. 2A and 2B. A user portal 456 can provide access for consumers and system administrators (not shown in FIG. 4). In some embodiments, a user portal 456 can provide security and/or identity verification for cloud consumer devices (e.g., the mobile device 145 and/or the mobile device 150, as shown in FIG. 1), as well as protection for data and other resources. A service level management resource 458 can provide cloud computing resource allocation and management such that required service levels are met. A service level agreement (SLA) planning and fulfillment resource 460 can provide pre-arrangement for, and procurement of cloud computing resources for which a future requirement is anticipated in accordance with an SLA.

A workloads layer 462 can provide functionality for which the cloud computing environment can be utilized. For example, a workloads layer 462 can include a mapping and navigation resource 464 for providing trip information and navigational information associated with the rideshare offer 175, including providing map information, walking instructions, driving instructions, providing distances, projecting time for travel, etc. A software development and lifecycle management resource 466 may be included, as well as a virtual delivery resource 468, a data analytics processing resource 470, a transaction processing resource 472, and the transactive controller 160, described with respect to FIGS. 2A, 2B, and 3.

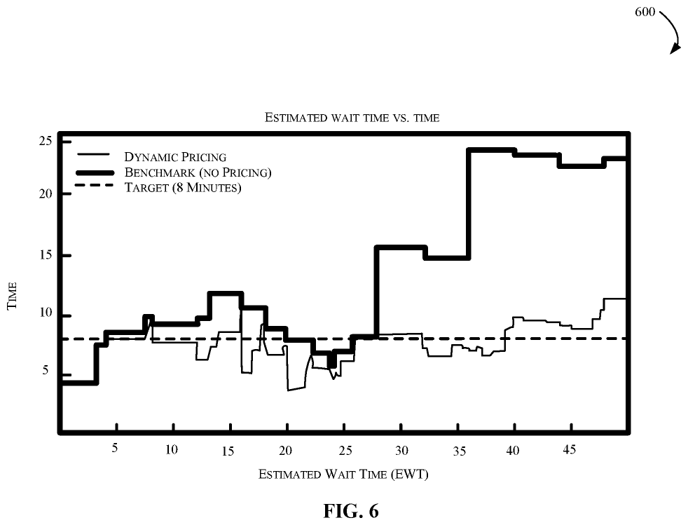

FIG. 5 is an example flow diagram of a method 500 for practicing an embodiment in accordance with the present disclosure. The method 500 may include a first step 505 of receiving, from a passenger mobile device, a request message indicative of a passenger request for transportation services.

A step 510 can include determining, based on the request message and the real time occupancy condition of the MoD platform, an updated estimated wait time (EWT) if the passenger would be accommodated.

A step 515 can include determining, based on the first EWT, a probability value indicative of whether the passenger mobile device will send an acceptance of a ride offer for passenger transport.

A step 520 can include generating, based on the probability value, a price for the ride offer associated with a reference transportation mode.

A step 525 can include sending a proposal message to the passenger mobile device, the proposal message comprising the ride offer, the price for the ride offer, and an itinerary comprising pickup information, and distance information.

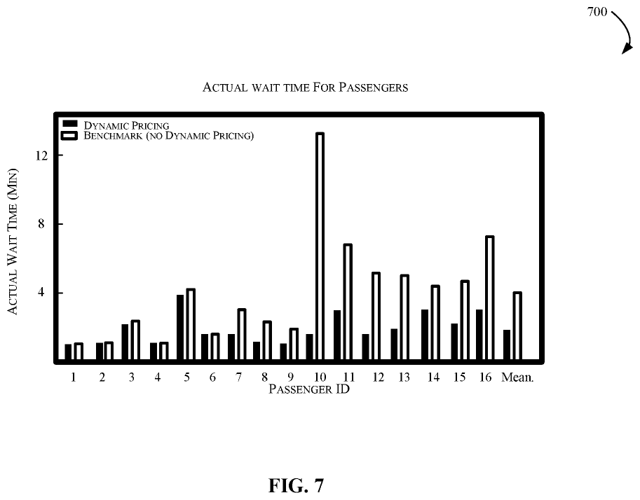

FIG. 6 depicts a graphical result of a computational experiment using actual rideshare operational data, where the dynamic pricing strategy described according to embodiments above were implemented for the rideshare service to regulate EWT(t) around the desired value EWT*, and the corresponding dynamic prices were calculated against two different reference transportation modes as an alternative, respectively.

The computational experiment of FIG. 6 represents a crowded scenario, or stated in another way, the demand was relatively higher than the supply, and the dynamic pricing strategy was implemented according to embodiments described herein to incentivize passengers, with the goal of balancing the demand with the supply.

In the experiment depicted in FIG. 6, a single rideshare driver was used to provide the study data. A total number of 16 requests were assumed to originate in 13 batches. The first four ride offers were assumed to be accepted by the corresponding passengers, with the passengers already on board. The Origin Destination (OD) pairs of the requests represent real operational location data from a rideshare service operating in San Francisco, United States, with modified timestamps of requests. Requests 5 through 16 were assumed to arrive 4 minutes apart over an interval of 44 minutes.

FIG. 6 depicts a graph 600 that summarizes how EWT(t) evolves with time via the disclosed dynamic pricing strategy, in comparison with the benchmark case where no pricing strategy is deployed and thus all passengers are assumed to accept the rideshare offers. The results show that EWT(t) is well regulated around the desired value EWT*, which was set to be 8 minutes in this computational experiment depicted in FIG.6. It should be noted that the dynamic pricing strategy described according to embodiments herein may have the capacity to yield an overall acceptance rate that is close to 80% according to the computational experiment. Such an acceptance rate may be desirable and is comparable to a current statistic of 70% corresponding to a percentage of passengers who decide to request ride services from a leading rideshare service (described hereafter as the rideshare service A) after seeing the prices.

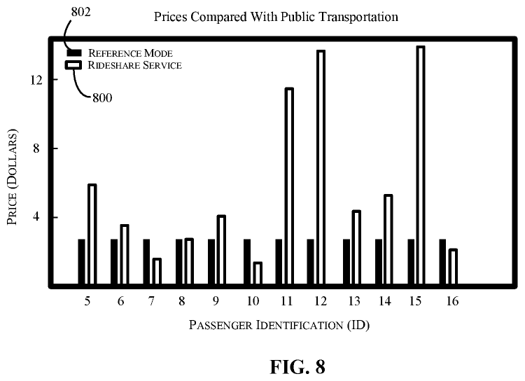

FIG. 7 provides a comparison 700 of Actual Wait Time (AWT) for all passengers and the average AWT with and without the disclosed dynamic pricing strategy, respectively. The comparison of FIG. 7 may provide data to evaluate an example performance of the dynamic pricing strategy with the Actual Wait Time (AWT) of taking the rideshare service, according to embodiments provided herein.

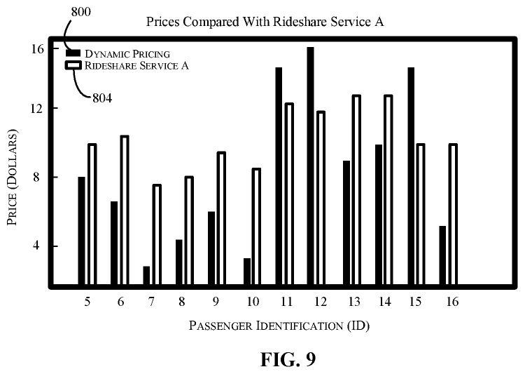

The corresponding prices of the rideshare service that the server offers to the passengers may be calculated using the dynamic pricing strategy elaborated with respect to FIG. 2. Test results for two different scenarios were considered and reflected in FIG. 7, where available public transportation and the rideshare service A were considered as the reference transportation modes that may be considered to be alternative(s) to the rideshare service if the prospective passenger decided to decline the rideshare offer. 100801 FIG. 8 and FIG. 9 illustrate the prices of the disclosed rideshare service 800 compared with those of the reference mode 802 (public transportation) and 804 (another rideshare service), respectively. For most of the passengers, prices of the disclosed rideshare service are higher than those of the public transportation, while lower than those of the rideshare service A. However, in FIG. 8, for passengers 7, 10, and 16, it was shown to be slightly cheaper to take the rideshare service than public transportation.

Similarly, in FIG. 8, for passengers 11, 12, and 15, taking the disclosed rideshare service was substantially more expensive than public transportation, because the disclosed rideshare system is now a bit crowded and the server would like to discourage the passengers from accepting the offer. Prices have thus been set to incentivize them to take the alternative mode instead.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A computer-implemented method, comprising:
receiving, from a mobile device, a request message indicative of a passenger request for transportation services,
determining, based on the request message, a first estimated wait time (EWT) to accommodate the passenger;
determining, based on the first EWT, a probability value indicative of whether an accept message to a ride offer for transport will be received from the mobile device;
generating, based on the probability value, a price for the ride offer; and
sending a proposal message to the mobile device, the proposal message comprising the ride offer, the price, and an itinerary comprising pickup information, and distance information.

2. The computer-implemented method according to claim 1, wherein the request message comprises a first preference for a transportation mode, the first preference comprising one or more of walking, bicycling, a personal mobility device, a bus, a rail line, or a private rideshare.

3. The computer-implemented method according to claim 2, wherein determining the probability value is based on a second EWT associated with a second preference of a transportation mode that is different from the first preference.

4. The computer-implemented method according to claim 3, wherein the request message comprises:
user authentication data associated with a passenger account;
a set of global positioning service (GPS) coordinates indicative of a destination; and
a preferred transportation mode.

5. The computer-implemented method according to claim 4, wherein determining the probability value comprises:
generating a target utility delta value indicative of an estimated utility perception associated with the first preference and the second preference;
retrieving a predetermined utility value indicative of a known utility for the first preference;
weighting the predetermined utility value based on user authentication data associated with a passenger;
generating a weighted utility value associated with the first preference; and
determining, based on the user authentication data and the target utility delta value, a first probability of an acceptance of the ride offer.

6. The computer-implemented method according to claim 1, wherein the proposal message is configured to configure the mobile device for:
displaying the ride offer;
requesting input indicative of an acceptance of the ride offer; and
sending an acceptance message indicative of one or more of a pickup location, a drop-off location, or a co-passenger identifier.

7. The computer-implemented method according to claim 1, wherein the ride offer comprises a pickup location, a drop off location, an expected time for arrival at the pickup location, and a walking distance from the drop off location to a passenger destination.

8. A system, comprising:
a processor; and
a memory for storing computer-executable instructions, the processor configured to execute the instructions to:
receive, from a mobile device, a request message indicative of a passenger request for transportation services,
determine, based on the request message, an first estimated wait time (EWT) to accommodate the passenger;
determine, based on the first EWT, a probability value indicative of whether an accept message to a ride offer for transport will be received from the mobile device;
generate, based on the probability value, a price for the ride offer; and
send a proposal message to the mobile device, the proposal message comprising the ride offer, the price, and an itinerary comprising pickup information, and distance information.

9. The system according to claim 8, wherein the request message comprises a first preference for a transportation mode, the first preference comprising one or more of walking, bicycling, a personal mobility device, a bus, a rail line, or a private rideshare.

10. The system according to claim 9, wherein determining the probability value is based on a second EWT associated with a second preference of a transportation mode that is different from the first preference.

11. The system according to claim 9, wherein the request message comprises:
user authentication data associated with a passenger account;
a set of global positioning service (GPS) coordinates indicative of a destination; and
a preferred transportation mode.

12. The system according to claim 11, wherein determining the probability value comprises:
generating a target utility delta value indicative of an estimated utility perception associated with a first preference and a second preference;
retrieving a predetermined utility value indicative of a known utility for the first preference;
weighting the predetermined utility value based on user authentication data associated with a passenger;
generating a weighted utility value associated with the first preference; and
determining, based on the user authentication data and the target utility delta value, a first probability of an acceptance of the ride offer.

13. The system according to claim 8, wherein the proposal message is configured to cause the mobile device to:
display the ride offer;
request input indicative of an acceptance of the ride offer; and
send an acceptance message indicative of one or more of a pickup location, a drop-off location, or a co-passenger identifier.

14. The system according to claim 8, wherein the ride offer comprises a pickup location, a drop off location, an expected time for arrival at the drop off location, and a walking distance from the drop off location to a passenger destination.

15. A non-transitory computer-readable storage medium comprising instructions that, when executed by one or more processors, cause the processors to perform acts comprising:
receiving, from a mobile device, a request message indicative of a passenger request for transportation services,
determining, based on the request message, a first estimated wait time (EWT) to accommodate the passenger;
determining, based on the first EWT, a probability value indicative of whether an accept message to a ride offer for transport will be received from the mobile device;
generating, based on the probability value, a price for the ride offer; and
sending a proposal message to the mobile device, the proposal message comprising the ride offer, the price for the ride offer, and an itinerary comprising pickup information, and distance information.

16. The non-transitory computer-readable storage medium according to claim 15, wherein the request message comprises a first preference for a transportation mode, the first preference comprising one or more of walking, bicycling, a personal mobility device, a bus, a rail line, or a private rideshare.

17. The non-transitory computer-readable storage medium according to claim 16, wherein determining the probability value indicative of whether the mobile device will send the acceptance of the ride offer is based on a second EWT associated with a second transportation mode of a plurality of transportation modes.

18. The non-transitory computer-readable storage medium according to claim 15, wherein the request message comprises:
user authentication data associated with a passenger account;
a set of global positioning service (GPS) coordinates indicative of a destination; and
a preferred transportation mode.

19. The non-transitory computer-readable storage medium according to claim 18, wherein determining the probability value indicative of whether the mobile device will send the acceptance of a ride offer comprises:
generating a target utility delta value indicative of an estimated utility perception associated with a first preference and a second preference;
retrieving a predetermined utility value indicative of a known utility for the first preference;
weighting the predetermined utility value based on user authentication data associated with a passenger;
generating a weighted utility value associated with the first preference; and
determining, based on the user authentication data and the target utility delta value, a first probability of an acceptance of the ride offer.

20. The non-transitory computer-readable storage medium according to claim 15, wherein the proposal message is configured to configure the mobile device for:
displaying the ride offer;
requesting input indicative of an acceptance of the ride offer; and
sending an acceptance message indicative of one or more of a pickup location, a drop-off location, or a co-passenger identifier.
